(19) United States
(12) Patent Application Publication
(10) Pub. No.: US 2025/0376191 A1
(43) Pub. Date: Dec. 11, 2025

(54) COMPUTER-IMPLEMENTED METHOD AND SYSTEM FOR MONITORING TRAJECTORY SUGGESTIONS FOR AN AUTOMATED OPERATING MODE OF A VEHICLE

(71) Applicant: Robert Bosch GmbH, Stuttgart (DE)

(72) Inventors: Johannes Christian Mueller, Stuttgart (DE); Anne Von Vietinghoff, Renningen (DE); Christian Heinzemann, Vellmar (DE); Heiko Freienstein, Weil Der Stadt (DE); Jens Oehlerking, Stuttgart (DE); Martin Herrmann, Korntal (DE); Martin Butz, Steinheim An Der Murr (DE); Max Keller, Berlin (DE); Michael Rittel, Markgroeningen (DE); Ralf Kohlhaas, Calw (DE); Stefan Ruppin, Grafenau (DE); Steffen Knoop, Hohenwettersbach (DE)

(21) Appl. No.: 19/222,265

(22) Filed: May 29, 2025

(30) Foreign Application Priority Data
Jun. 7, 2024 (DE) 10 2024 205 239.6

(51) Int. Cl. B60W 60/00; B60W 30/182

(52) U.S. Cl. CPC B60W 60/0011; B60W 30/182; B60W 60/0053; B60W 60/0059

(57) ABSTRACT

A computer-implemented method and system which enable a practical verification and meaningful evaluation of trajectories suggested by a planning module for an automated operating mode of a vehicle. The method includes: aggregating situation-specific information; generating a surroundings model based on the situation-specific information; ascertaining possible behaviors of the vehicle based on the situation-specific information and the surroundings model, wherein each behavior is described by a set of boundary conditions; and prioritizing the possible behaviors of the vehicle based on the boundary conditions in conjunction with a predefined set of rules. A compatibility check is carried out for a suggested trajectory and at least one of the ascertained behaviors by checking whether the suggested trajectory satisfies the boundary conditions of the respective behavior. The suggested trajectory is then evaluated based on the results of these compatibility checks and the prioritizations of the respective behaviors.

### CROSS REFERENCE

The present application claims the benefit under 35 U.S.C. § 119 of German Patent Application No. DE 10 2024 205 239.6 filed on Jun. 7, 2024, which is expressly incorporated herein by reference in its entirety.

### FIELD

The present invention relates to a computer-implemented method and a computer-implemented system for monitoring trajectories suggested by at least one planning module for an automated operating mode of a vehicle.

Such methods and systems are used in the context of behavior planning for partially or fully automated vehicles.

### BACKGROUND INFORMATION

Automated vehicles have to also operate in complex situations that sometimes change very quickly and unexpectedly. Appropriate behavior planning requires methods and systems that meet very high safety requirements. For this reason, systems with a multi-path architecture are often used in practice. A first path, the so-called performance path, comprises at least one planning module for generating trajectories that each describe a possible behavior of the automated vehicle for the given situation and can be implemented by the actuator system of the vehicle. These trajectories can be generated based on rules. However, planning modules that use artificial intelligence (AI) methods for trajectory planning are often used as well. To ensure that a trajectory suggestion from the planning module meets the requirements of the given situation and is also safe, this suggestion is checked and evaluated in a second path, the so-called safety path, by an independent further component. This component is also referred to as the “safety monitor”.

Checking trajectory suggestions, in particular with respect to their functional safety, and a practical and meaningful evaluation of trajectory suggestions present special challenges.

### SUMMARY

A method according to an example embodiment of the present invention first analyzes the given traffic situation and for this purpose carries out the following method steps:
aggregating situation-specific information,
generating a surroundings model based on the situation-specific information,
ascertaining possible behaviors of the vehicle based on the situation-specific information and the surroundings model, wherein each behavior is described by a set of boundary conditions, and
prioritizing the possible behaviors of the vehicle based on the boundary conditions in conjunction with a predefined set of rules.

For this analysis of the given situation, the so-called SOCA method can be used, for example, as presented in the publication M. Butz et al., “SOCA: Domain Analysis for Highly Automated Driving Systems,” 2020 IEEE 23rd International Conference on Intelligent Transportation Systems (ITSC), 2020, pp. 1-6, doi: 10.1109/ITSC45102.2020.9294438. The SOCA method is used to analyze traffic situations with the objective of determining boundary conditions or requirements for the behavior of an automated vehicle, referred to hereinafter as the EGO vehicle, in the respective traffic situation. This involves first creating an abstract description of the traffic situation to be analyzed. This description uses so-called zone graphs. A zone graph abstracts the traffic situation to be analyzed by representing the real road situation using a corresponding abstract traffic infrastructure element (static road geometry) with different zones that are relevant to the realization of the driving intention of the EGO vehicle, but are initially specified neither in terms of their size nor in terms of their position. The different zones can represent different map regions, possible traffic flows, objects, etc. This abstract description of the traffic situation is then used to determine and morphologically analyze the possible developments or the behavior of the road users involved in order to determine boundary conditions for the behavior of the EGO vehicle in the analyzed traffic situation. It is worth noting that the results or boundary conditions obtained in this way initially apply to all traffic situations with the same zone graph. Specification does not take place until the results are provided with the data of the situation-specific parameters of the analyzed traffic situation.

The prioritization ranks the possible behaviors of the vehicle ascertained for a given situation in an order that is determined by the predefined set of rules.

German Patent Application No. DE 10 2023 201 983.3 describes such a method for prioritizing the possible behaviors of a vehicle based on the boundary conditions that define these behaviors and in conjunction with a predefined set of rules. The prioritization is automated here and is carried out dynamically during the runtime of the system. It does not require a special metric, but is based solely on a decision-process structure of the rule set.

According to the present invention, it has been recognized that such an analysis of the given traffic situation can not only be used for behavior planning, but is also very well suited for checking trajectory suggestions of a planning module, specifically for a check that is appropriate to the context of the traffic situation. The result of this check then also enables a practical and meaningful evaluation of the suggested trajectories.

According to an example embodiment of the present invention, a compatibility check is carried out for a suggested trajectory and at least one of the ascertained possible behaviors of the vehicle in the given situation. This involves checking whether the suggested trajectory satisfies the boundary conditions of the respective behavior. The suggested trajectory is then evaluated based on the results of these compatibility checks and the prioritizations of the respective behaviors.

The compatibility checks are therefore first used to check the validity of a trajectory. In other words, there is first a check whether the trajectory corresponds to at least one behavior that has been ascertained as a possible behavior of the vehicle in the given situation. These compatibility checks can, for instance, also be used to determine which boundary conditions of which behaviors are not being observed. This is followed by the evaluation of the quality of the trajectory. This not only takes into account the validity with respect to the individual behaviors, but also their ranking or prioritization. Since this is determined using the predefined set of rules, user-defined evaluation criteria, such as violation of traffic rules, endangerment of other road users, etc., can be taken into account here.

In principle, there are many options for evaluating the trajectories in the context of the method according to the present invention.

In a preferred embodiment of the present invention, a trajectory is simply evaluated based on the highest prioritization of all checked behaviors the boundary conditions of which it satisfies and/or based on the lowest prioritization of all checked behaviors the boundary conditions of which it does not satisfy. These priorities can then simply be adopted as the evaluation.

It would also be possible to consider the priorities of all behaviors the boundary conditions of which are satisfied by the trajectory, or only consider priorities of behaviors the boundary conditions of which are not satisfied by the trajectory, and then weight these priorities, for example depending on which boundary conditions are being violated and/or observed.

All of these evaluations are highly meaningful in terms of the given traffic situation and user-defined quality criteria, because the priorities represent the quality of the respective behavior with respect to the predefined set of rules.

The method according to the present invention can advantageously be used in the context of behavior planning for a vehicle when one of a number of suggested trajectories has to be selected for implementation in the automated operating mode. These trajectories can be suggested by a planning module. However, the method according to the present invention can also advantageously be integrated into a multi-path architecture comprising a plurality of different planning modules that suggest trajectories independently of one another. In any case, the method according to the present invention enables a comparison of the different trajectory suggestions based on the results of the compatibility checks and/or the evaluations of the suggested trajectories. According to the present invention, this comparison takes into account the quality criteria that have been ascertained for the given traffic situation and is therefore particularly meaningful.

In a preferred embodiment of the present invention, the results of the compatibility checks and/or the evaluations of the suggested trajectories are cached or stored. These data can then advantageously be used for documentation purposes. This is of particular interest, for instance, if an emergency occurred in which a critical trajectory was executed because the behavior planning did not find any non-critical alternatives as a recourse. The stored results of the compatibility checks and the trajectory evaluations can easily be used to reconstruct and explain such a decision.

In an advantageous further development of the method according to the present invention, the results of the compatibility checks and/or the evaluation of a trajectory are made available to the planning component that suggested the trajectory. This feedback can be used to improve the performance of the planning component.

The method according to the present invention can also be used to identify critical situations. These are usually characterized by an unexpected development of the traffic scene. The analysis of such traffic situations as part of the method according to the present invention then provides more behaviors for the vehicle that are not rule-compliant or are given only a very low priority based on the predefined set of rules. In most cases, the trajectory suggestions of the planning module are only limitedly suitable for such situations. This has a significant effect on the results of the compatibility checks, but primarily also on the evaluation according to the present invention of these trajectory suggestions. Critical situations can therefore be identified relatively easily based on the results of the compatibility checks and/or the evaluation of the suggested trajectory.

This capability can advantageously be used to generate a so-called “take-over request” when a critical situation has been identified, i.e. a signal to terminate the automated operating mode and transition to a manual operating mode.

The method according to the present invention can furthermore also be used to trigger permanent storage of the continuously aggregated and cached situation-specific information when a critical situation has been identified. These data can then be used to better deal with critical situations in the future and ideally avoid them. For this purpose, the situation-specific information, in particular sensor data and internal status data, is temporarily stored in a circular buffer during ongoing operation. If a critical situation has been identified, the data of the circular buffer is transferred to a persistent memory, from which it can then be transmitted anonymously as soon as a stable data connection is established. A thus generated data set can be used for the further development and verification of automated driving functions, for example.

As mentioned above, the present invention relates not only to a computer-implemented method but also to a computer-implemented system for monitoring trajectories suggested by at least one planning module for an automated operating mode of a vehicle. The system according to an example embodiment of the present invention comprises a perception layer for aggregating situation-specific information from vehicle-internal and vehicle-external information sources. The vehicle-internal information sources can be in-vehicle sensors, such as LiDAR sensors, radar sensors and/or RGB cameras installed on the vehicle, that acquire the surroundings of the vehicle, or sensors that acquire the status data of the vehicle, such as speed, orientation, etc. The vehicle-external information sources can be sensors, such as LiDAR sensors, radar sensors, and/or RGB cameras installed on infrastructure elements or other road users. Other possible sources of information include stored map information as well as retrievable weather and road condition information, traffic situation information, etc. The information from the different sources of information is aggregated by the perception layer and, if necessary, preprocessed into context information.

The system according to an example embodiment of the present invention further comprises an evaluation module for generating a surroundings model based on the aggregated situation-specific information and an analysis module for ascertaining possible behaviors of the vehicle based on the situation-specific information and the surroundings model, wherein each behavior is described by a set of boundary conditions. The system according to the present invention moreover has a predefined set of rules available to it, which is used to evaluate and prioritize the possible behaviors based on their respective boundary conditions.

A component of the system that is important to the present invention is an evaluation module for the suggested trajectories that is configured to carry out a compatibility check for a suggested trajectory and at least one of the ascertained behaviors by checking whether the suggested trajectory satisfies the boundary conditions of the respective behavior. This evaluation module is further configured to then evaluate the suggested trajectory based on the results of these compatibility checks and prioritizations of the respective behaviors.

The evaluation module can also be configured to evaluate multiple trajectories suggested by one or more planning modules in parallel and compare the results of the compatibility checks and/or the evaluations of the suggested trajectories with one another. This proves to be advantageous in particular when using the system according to the present invention as a safety monitor of a behavior planner with a multi-path architecture.

According to an example embodiment of the present invention, the evaluation module is preferably configured to make the results of the compatibility checks and/or evaluation of the suggested trajectory available via at least one interface, in particular to a downstream control module for selecting a trajectory that is then to be implemented by the actuator system of the vehicle. However, this interface can also be used to provide feedback to the planning module that suggested the trajectory.

The system according to an example embodiment of the present invention advantageously further comprises at least one memory module for storing selected trajectories together with the associated results of the compatibility checks and/or the associated evaluations, so that it can log the trajectory suggestions of a planning module and their evaluations and use them as a type of tachograph.

In a further advantageous embodiment of the present invention, the system according to the present invention is equipped with a warning function. In that case, the evaluation module is configured to use the results of the compatibility checks and/or the evaluation of the suggested trajectory to determine the existence of a critical situation. The evaluation module can then generate a “take-over request”, i.e., a signal to terminate the automated operating mode and transition to a manual operating mode.

### BRIEF DESCRIPTION OF THE DRAWINGS

Embodiment examples and advantageous further developments of the present invention are explained in more detail in the following in conjunction with the figures.

FIG. 1 illustrates the measures according to an example embodiment of the present invention for monitoring trajectories suggested by a planning module in the context of behavior planning for a vehicle.

FIG. 2 shows a block diagram of a system for behavior planning with a multi-path architecture in which a safety monitor according to an example embodiment of the present invention is integrated.

### DETAILED DESCRIPTION OF EXAMPLE EMBODIMENTS

The starting point for behavior planning for an automated driving function of a vehicle traveling toward a specified destination is always the state of the traffic scene at a time of planning, and in particular the state of all of the participants in the traffic scene at the time of planning. The state of the traffic scene is described by situation-specific information that is aggregated at the time of planning, or also over a certain period of time before and up to the time of planning, from different vehicle-internal and/or vehicle-external information sources. For this purpose, the vehicle is typically equipped with a perception layer that includes the necessary sensors and usually also suitable data processing means.

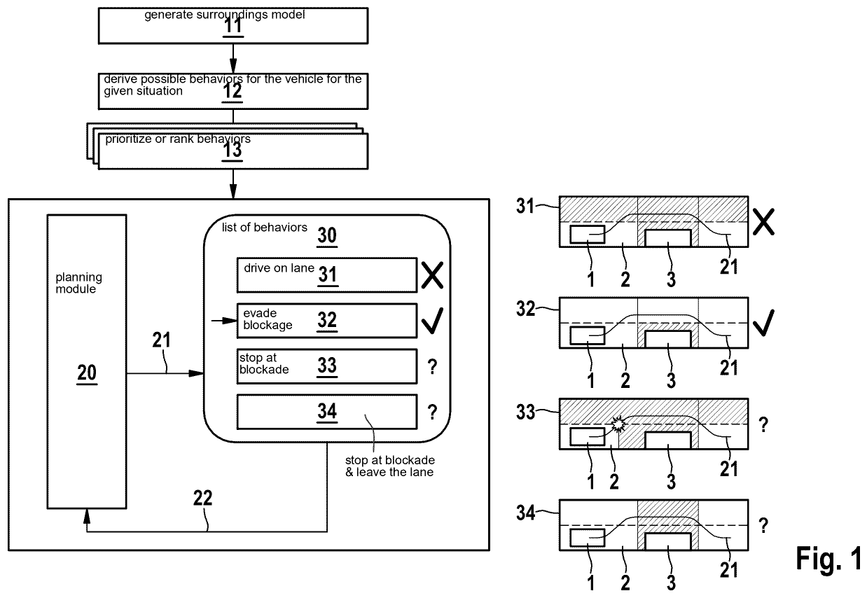

In the embodiment example described in connection with FIG. 1, a planning module 20 generates a trajectory 21 based on the specified destination and the aggregated situation-specific information, which is to be checked and evaluated with the aid of the method according to the present invention.

For this purpose, the given traffic scene is first analyzed based on the specified destination and the aggregated situation-specific information. In a first analysis step 11, a specific surroundings model is generated. In the present case, this is an abstract description of the traffic situation in accordance with the aforementioned SOCA method. In a second analysis step 12, possible behaviors of the vehicle for the given situation are derived from this abstract description of the traffic situation in conjunction with the situation-specific information, wherein each behavior is described by a set of boundary conditions.

These behaviors are then prioritized or ranked in a third analysis step 13 using a predefined set of rules.

The predefined set of rules assigns semantics to the possible behaviors and enables a prioritization of the behaviors based on a safety argumentation, wherein behaviors with increasingly relaxed boundary conditions are assigned ever-decreasing priority. The relaxation of the boundary conditions can be broadly grouped into the categories functional degradation, violation of traffic rules and endangering or harming road users. Functional degradation occurs, for example, when the vehicle is required to stop in front of an intersection instead of crossing it. A violation of traffic rules would be driving over a stop line because the vehicle can no longer brake in time, for example, or driving at excessive speed. An example of a relaxation of the category endangering or harming road users would be crash mitigation that accepts vehicle body damage to protect the lives of vulnerable road users.

FIG. 1 shows the outcome of this prioritization in the form of a corresponding list 30 of behaviors 31 to 34 with descending priorities. These behaviors 31 to 34 are shown again in the right half of FIG. 1; specifically for a given traffic situation with a vehicle 1 on a two-lane road 2 and with an obstacle 3 in front of the vehicle 1 in the direction of travel. The prohibited zones for the vehicle 1 are depicted with cross-hatching. The respective trajectory suggestion 21 is shown as a line. The individual behaviors 31 to 34 are characterized or defined by the following boundary conditions:
31 “Drive on lane”—driving around the obstacle 1 without leaving the lane,
32 “Evade blockade”—driving around the obstacle 1 while changing lanes into the opposite lane,
33 “Stop at blockade”—stopping in front of the obstacle 1,
34 “Stop at blockade & leaving the lane”—stopping in front of the obstacle 1, while changing lanes into the opposite lane.

According to the present invention, the trajectory 21 suggested by the planning module 20 is subjected to a compatibility check by checking whether it satisfies the boundary conditions of at least one of the behaviors 31 to 34. For this purpose, the individual behaviors 31 to 34 are checked in the order of rank in the list 30.

The highest-priority behavior 31 stipulates that the vehicle 1 drives around the obstacle 3 without leaving its lane. As can be seen from the scenic representation 31, trajectory 11 does not satisfy these boundary conditions, which is symbolized here by an x.

The next possible behavior 32 in the list 30 stipulates driving around the obstacle 1, even if this requires a lane change to the opposite lane, since no oncoming traffic is expected. Trajectory 11 satisfies this behavior 32, which is symbolized here by a checkmark. In the embodiment example described here, the compatibility check is aborted at this point because a possible behavior has been identified that satisfies the suggested trajectory.

The suggested trajectory 21 is now evaluated based on the results of the compatibility checks and the prioritizations of the respective behaviors. In this case, the trajectory 21 is simply assigned an evaluation corresponding to the priority of the behavior 32.

It should be noted here that other behaviors from the list of possible behaviors can also be checked as part of the method according to the present invention, which is useful, for example, if a more differentiated evaluation of the trajectory is to be carried out.

The more boundary conditions have to be relaxed and the more critical the relaxation, the worse an input trajectory is evaluated. In particular trajectories that violate traffic rules or even unduly endanger other road users are generally rejected as invalid and accepted only in absolute emergencies in which the vehicle has no other recourse. In these cases, it proves to be advantageous if the critical input trajectory is stored in a log file together with the results of the compatibility checks and the resulting evaluation. This documentation can then be used to reconstruct both the incident and the safety justification for the decision behind the input trajectory.

In the present embodiment example, the results of the compatibility checks and/or the evaluation of the suggested trajectory 21 are fed back to the planning module 20 in a feedback loop 22. The highest-priority, satisfied behavior 32 is thus fed back to the planning module 20. Feedback is also provided on which higher-priority behaviors-behavior 31—does not satisfy the input trajectory 21.

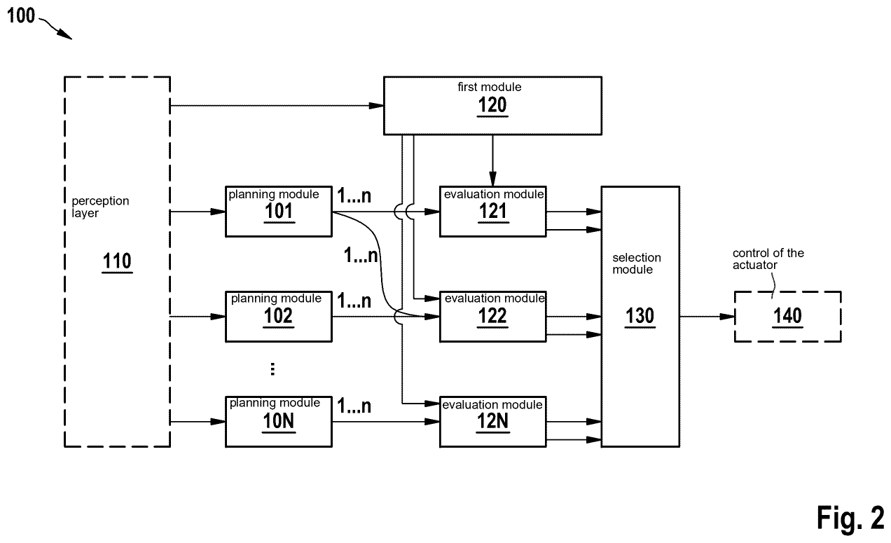

As mentioned at the outset, a safety monitor according to the present invention can advantageously be integrated into the multi-path architecture of a system for behavior planning for a vehicle. Such an embodiment example is shown in FIG. 2.

The system 100 shown here comprises a perception layer 110 for aggregating and possibly also preprocessing scene-specific or situation-specific information of a traffic scene. The thus prepared situation-specific information is fed to multiple planning modules 101, 102, . . . 10N that suggest trajectories for the vehicle in parallel, in independent paths based on the situation-specific information. The planning modules 101, 102, . . . 10N can be identical. However, they can also be different planning modules that use rule-based methods and/or AI-based methods to generate trajectories.

The situation-specific information is also fed to a first module 120 of a safety monitor according to the present invention. This module 120 analyzes the given traffic situation based on the situation-specific information and then generates a prioritized list of possible behaviors for the vehicle in the given situation with the aid of a predefined set of rules. In the here-described embodiment example, the module 120 thus comprises the functionality of an evaluation module for generating a surroundings model based on the situation-specific information, the functionality of an analysis module for ascertaining possible behaviors of the vehicle based on the situation-specific information and the surroundings model, wherein each behavior is described by a set of boundary conditions and a predefined set of rules for evaluating and prioritizing the possible behaviors based on their particular boundary conditions.

For each planning module 101, 102, . . . 10N, the here-described safety monitor further comprises an evaluation module 121, 122, . . . 12N to which the prioritized list of possible behaviors is made available. These evaluation modules 121, 122, . . . 12N are respectively disposed in the performance path of the associated planning module 101, 102, . . . 10N, so that the trajectory suggestions of the planning modules can be checked and evaluated in parallel. The check includes compatibility checks, as described in detail in connection with FIG. 1, from which an evaluation is then derived in conjunction with the prioritized list of behaviors.

It should be noted here that the trajectories of a planning module can also be checked and evaluated by an evaluation module other than the one assigned to it, for example if the functionality of an evaluation mode is limited. This option is indicated here for the planning module 101, the trajectories of which are forwarded to both the evaluation module 121 and the evaluation module 122.

The individual trajectory suggestions are fed to a selection module 130 together with the results of the respective evaluation module 121, 122, . . . 12N, which is why the evaluation modules 121, 122, . . . 12N are each shown here with a first output arrow for the trajectory suggestion and a second output arrow for the evaluation results. In the selection module 130, the evaluation results are compared with one another in order to select exactly one trajectory for the control 140 of the actuator system of the vehicle.

What is claimed is:

1. A computer-implemented method for monitoring trajectories suggested by at least one planning module for an automated operating mode of a vehicle, the method comprising the following steps:
aggregating situation-specific information;
generating a surroundings model based on the situation-specific information;
ascertaining possible behaviors of the vehicle based on the situation-specific information and the surroundings model, wherein each behavior of the possible behaviors is described by a set of boundary conditions; and
prioritizing the possible behaviors of the vehicle based on the boundary conditions in conjunction with a predefined set of rules;
wherein a compatibility check is carried out for a suggested trajectory and at least one respective behavior of the ascertained behaviors by checking whether the suggested trajectory satisfies the boundary conditions of the respective behavior, and the suggested trajectory is then evaluated based on results of the compatibility checks and the prioritizations of the respective behaviors.

2. The method according to claim 1, wherein the suggested trajectory is evaluated based on a highest prioritization of all checked behaviors the boundary conditions of which it satisfies, and/or based on a lowest prioritization of all checked behaviors the boundary conditions of which it does not satisfy.

3. The method according to claim 1, wherein multiple trajectories suggested by one or more planning modules are compared to one another based on results of the compatibility checks and/or the evaluations of the suggested trajectories in order to select a trajectory for implementation in the automated operating mode based on the comparison.

4. The method according to claim 1, wherein the results of the compatibility checks and/or the evaluation of the suggested trajectory are cached or stored.

5. The method according to claim 1, wherein the results of the compatibility checks and/or the evaluation of the trajectory are made available to the planning component that suggested the trajectory.

6. The method according to claim 1, wherein the results of the compatibility checks and/or the evaluation of the suggested trajectory are used to determine an existence of a critical situation.

7. The method according to claim 6, wherein a signal to terminate the automated operating mode and transition to a manual operating mode is generated when a critical situation has been identified.

8. The method according to claim 6, wherein the aggregated situation-specific information is continuously cached and the cached situation-specific information is permanently stored when a critical situation has been identified.

9. A computer-implemented system for monitoring trajectories suggested by at least one planning module for an automated operating mode of a vehicle, the system comprising:
a perception layer configured to aggregate situation-specific information from vehicle-internal and vehicle-external information sources;
an evaluation module configured to generate a surroundings model based on the situation-specific information;
an analysis module configured to ascertain possible behaviors of the vehicle based on the situation-specific information and the surroundings model, wherein each behavior of the possible behaviors is described by a respective set of boundary conditions;
a predefined set of rules for evaluating and prioritizing the possible behaviors based on their respective boundary conditions, and
an evaluation module for the suggested trajectories, which is configured to:
carry out a compatibility check for a suggested trajectory and at least one respective one of the ascertained behaviors by checking whether the suggested trajectory satisfies the boundary conditions of the respective behavior, and
after the carrying out, evaluate the suggested trajectory based on results of the compatibility checks and the prioritizations of the respective behaviors.

10. The system according to claim 9, wherein the evaluation module is configured to evaluate multiple trajectories suggested by one or more planning modules in parallel and compare the results of the compatibility checks and/or the evaluations of the suggested trajectories with one another.

11. The system according to claim 9, wherein the evaluation module is configured to make the results of the compatibility checks and/or evaluation of the suggested trajectory available via at least one interface, to a downstream control module and/or to the planning module that suggested the trajectory.

12. The system according to claim 9, further comprising:
at least one memory module for storing selected trajectories together with the associated results of the compatibility checks and/or the associated evaluations.

13. The system according to claim 9, wherein the evaluation module is configured to use the results of the compatibility checks and/or the evaluation of the suggested trajectory to determine an existence of a critical situation, and generate a signal to terminate the automated operating mode and transition to a manual operating mode when a critical situation has been identified.
